(19) United States
(12) Patent Application Publication
(10) Pub. No.: US 2025/0140012 A1
(43) Pub. Date: May 1, 2025

(54) MULTI-MODAL MACHINE LEARNING MODEL FOR DIGITAL DOCUMENT PROCESSING

(71) Applicant: Intuit Inc., Mountain View, CA (US)

(72) Inventors: Tharathorn RIMCHALA, San Francisco, CA (US); Shir Meir LADOR, Sunnyvale, CA (US); Xiangru LI, Mountain View, CA (US)

(73) Assignee: Intuit Inc., Mountain View, CA (US)

(21) Appl. No.: 18/383,799

(22) Filed: Oct. 25, 2023

(51) Int. Cl. G06V 30/416; G06V 10/82; G06V 30/19; G06V 30/414

(52) U.S. Cl. CPC G06V 30/416; G06V 10/82; G06V 30/19147; G06V 30/1916; G06V 30/414

(57) ABSTRACT

A method including receiving a digital image including text arranged in a layout. The method also includes generating, by an optical character recognition model, a layout text vector that encodes at least one word in the text of the digital image and a position of the at least one word in the layout of the digital image. The method also includes generating, by a visual encoder model, a visual representation vector embedding a content of the digital image. The method also includes converting both the layout text vector and the visual representation vector into a projected text vector including a digital format suitable for input to a large language model. The method also includes combining, into a prompt, the projected text vector, a system message, and a task instruction. The method also includes generating an output including a key-value pair.

### BACKGROUND

Optical character recognition (OCR) may be used to extract text from images. However, automatically processing information from digital images of documents may be difficult if more than raw text is desired from the digital image.

For example, the text may contain categories defined by words and also value entries defined by other words. In a specific example, consider a W-2 tax form. The W-2 form may include a text phrase “last name” (a type of text) and also the word “Doe” (a value for the type of text).

OCR algorithms only recognize text and do not identify the ontological relationships between different instances of text in the digital image. Again, for example, OCR algorithms do not recognize the relationship between “last name” (the type) and “Doe” (the value) in the W-2 form. Thus, further automated processing of the OCR text in the digital image may be impractical or impossible for some additional processing applications.

### SUMMARY

One or more embodiments provide for a method. The method includes receiving a digital image. The digital image includes text arranged in a layout within the digital image. The method also includes generating, by an optical character recognition model, a layout text vector that encodes at least one word in the text of the digital image and also encodes a position of the at least one word in the layout of the digital image. The method also includes generating, by a visual encoder model, a visual representation vector embedding a content of the digital image. The method also includes converting both the layout text vector and the visual representation vector into a projected text vector. The projected text vector includes a digital format suitable for input to a large language model. The method also includes combining, into a prompt, the projected text vector, a system message, and a task instruction. The method also includes generating an output including a key-value pair. A key of the key-value pair represents a type of the text and a value of the key-value pair represents a value of the type. The output is generated by the large language model which takes, as input, the prompt.

One or more embodiments provide for another method. The method includes receiving training data including a reference output for a digital image. The digital image includes text arranged in a layout within the digital image. The method also includes performing a first sub-method including generating, by a visual encoder model, a visual representation vector embedding a content of the digital image. The sub-method also includes converting, using a projection network model, the visual representation vector into a projected text vector. The projected text vector includes a digital format suitable for input to a large language model. The sub-method also includes combining, into a prompt, the projected text vector, a system message, and a task instruction. The sub-method also includes generating, using a large language model that takes the prompt as input, an output including a sequence of next tokens in an optical character recognition text determined for the text in the image. The method also includes generating a loss function by comparing the output to the reference output. The method also includes adjusting, based on the loss function, one or more parameters in the projection network model. The method also includes training a first trained projection network model by iterating, until convergence, receiving the training data, performing the first sub-method, generating the loss function, and adjusting the one or more parameters. Upon convergence the projection network model is transformed into the first trained projection network model.

One or more embodiments also provide for a system. The system includes a computer processor and a data repository in communication with the computer processor. The data repository includes a digital image including text arranged in a layout within the digital image. The data repository also includes a layout text vector that encodes at least one word in the text of the digital image and also encodes a position of the at least one word in the layout of the digital image. The data repository also includes a visual representation vector embedding a content of the digital image. The data repository also includes a projected text vector. The projected text vector includes a digital format suitable for input to a large language model. The data repository also includes a prompt. The data repository also includes a system message. The data repository also includes a task instruction. The data repository also includes an output including a key-value pair. A key of the key-value pair represents a type of the text and a value of the key-value pair represents a value of the type. The system also includes an optical character recognition model which, when executed by the computer processor, is programmed to generate the layout text vector. The system also includes a visual encoder model which, when executed by the computer processor, is programmed to generate visual representation vector. The system also includes a projection network model which, when executed by the computer processor, is programmed to generate the projected text vector. The system also includes a prompt generator which, when executed by the computer processor, is programmed to generate the prompt by combining the projected text vector, the system message, and the task instruction. The system also includes the large language model which, when executed by the computer processor, is programmed to generate the output including the key-value pair.

Other aspects of the one or more embodiments will be apparent from the following description and the appended claims.

### BRIEF DESCRIPTION OF DRAWINGS

FIG. 1A and FIG. 1B show a computing system, in accordance with one or more embodiments.

FIG. 2, FIG. 3A, and FIG. 3B show methods, in accordance with one or more embodiments.

FIG. 4A, FIG. 4B, FIG. 4C, FIG. 4D, FIG. 4E, and FIG. 4F show an example, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

In general, embodiments are directed to technical improvements in the automated processing of documents that are stored in the format of digital images. A digital image (e.g., a photograph, a scanned document, or other such image) is stored in one of a number of different image file formats, such as. jpg, .png, .tif, etc. Digital images may contain text that represents a type of information (also known as key entity information) which, without additional processing, may not be automatically distinguishable from other text that represents a value of that type of text. However, in many cases it may be useful to extract the types of text (key information entities (KIEs)) and the values of the types of text from the digital image. Thus, the technical problem presented is how to extract automatically the types of text and the values of the types when the initial available input is a digital image.

The technical problem may be made worse because optical character recognition algorithms cannot recognize phrases. For example, the phrase “last name” is two words, but an OCR algorithm cannot recognize that the two words should be considered as a single term. In other words, OCR algorithms only recognize the words “last” and “name” without associating the two together as a single type (category or KIE) of information. Thus, while an optical character recognition algorithm may be able to generate text from a digital image, such text information may be useless with respect to further automated processing of the text information in some applications.

The technical problem may be made still more difficult in that the layout of the text in the digital image may confer additional meaning and context to the information beyond the meaning of the text itself. For example, the location of a number (i.e., a type of text) in the digital image of a W-2 form may convey some knowledge regarding what the number is used for (i.e., the meaning and context of the text) when automatically preparing a tax form using the OCR text. Optical character recognition algorithms do not recognize the impact that the location of text within the digital image may have on the meaning or value of the text. Thus, further automated processing of text scraped from digital images of complex forms, such as tax forms, is a serious technical problem.

One or more embodiments described herein provide one or more technical solutions to the above-described technical problems. Briefly, one or more embodiments provide for a multi-modal machine learning model for digital document processing. One or more embodiments do generate OCR text, but in addition a multimodal machine learning model is used to verify the text in the digital image and to account for both the semantics of the text in the digital image and the impact that the two dimensional position of the words in the digital image may have on the meaning of the text.

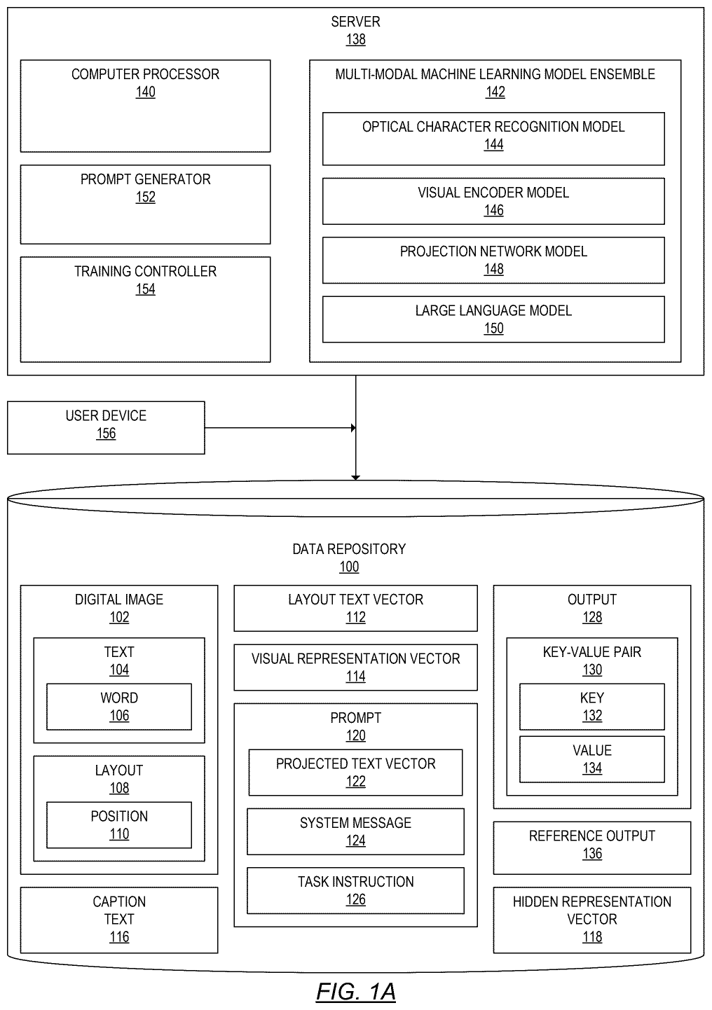

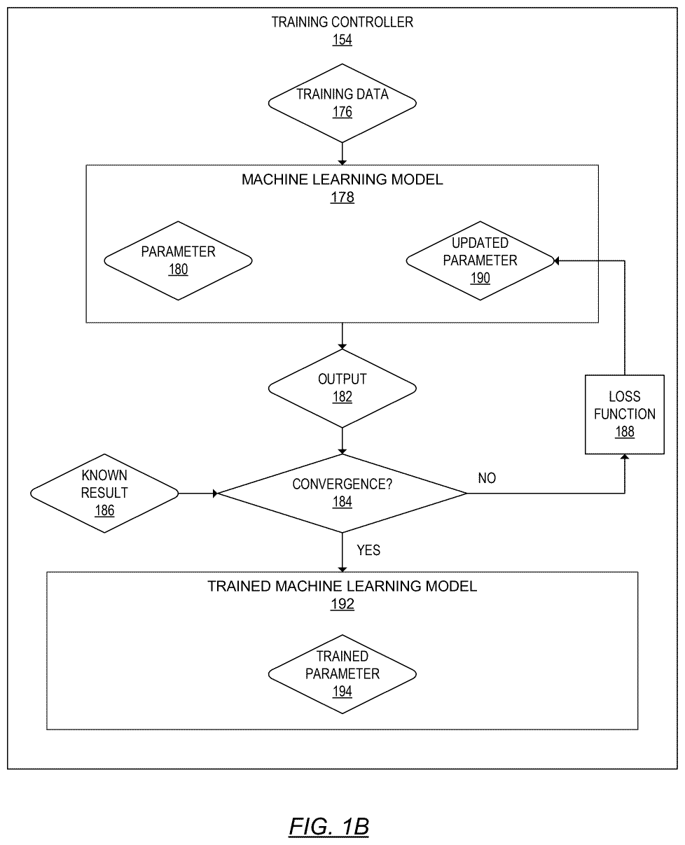

More specifically, as shown further in FIG. 1A and in FIG. 3A, a combination of an optical character recognition model, a visual encoder model, a projection network model, and a large language model may, when used as described herein, generate an output which contains not only the text, but the relationships among the text in the context of the layout of the text in the digital image. In other words, the output of one or more embodiments described herein may be the text in the digital image, but arranged in key-value pairs. The keys represent the types of the text and the values represent the values of the types. For example, one or more embodiments may take a digital image containing text as input and recognize, as output, that the term “last name” in the text is a key and the term “Doe” in the text is a value of the last name.

The optical character recognition model is an optical character recognition machine learning model trained to perform optical character recognition. The input of the optical character recognition model is the digital image, and the output is a layout text vector that encodes at least one word in the text of the digital image and also encodes a position of the at least one word in the layout of the digital image.

The visual encoder model is a machine learning model trained to generate a visual representation vector of a digital image. The visual encoder model may take a digital image (e.g., a digital image of a child reaching for a banana) as input, and then automatically generate a visual representation vector that embeds a content of a digital image. Note that ordinarily visual encoders take the digital image as input and generates a caption as output. A caption is text that describes the image (e.g. text that states, “a child is reaching for a banana.”) However, one or more embodiments may instead take, as the output of the visual encoder model, a hidden representation vector output by the inner layers of the visual encoder model. The reason is that the caption text may not be useful or desirable in one or more embodiments.

The layout text vector and the visual representation vector may not be suitable for use as an input to a large language model. Thus, one or more embodiments include a projection network model, which is another machine learning model. The projection network model takes, as input, the layout text vector and the visual representation vector and generates, as output, a projected text vector. The projected text vector is a transformation of the layout text vector and the visual representation vector such that the projected text vector contains the information in the digital image, including both the text and the layout of the text, but is now in a format suitable for input to the large language model.

The large language model, in turn, takes a prompt as input. The prompt may include or reference a task instruction (e.g., analyze the text in the document), but the pre-engineered instruction of one or more embodiments also includes the projected text vector and a system message that specifies the scope and capabilities of the large language model when given a task.

When the large language model processes the prompt, the large language model has available the impact that the layout of the text in the digital image has on the meaning of the text. The large language model is also capable of analyzing the semantic or ontological meaning of terms and phrases, and thus may determine types of text, the values of the types of text, and further may recognize that both types and values may be formed from multiple word phrases.

The output of the large language model is sets of structured text that includes key-value pairs. The keys are types of text (KIEs) (expressed in text) and corresponding values of the types (also expressed in text). The key-value pairs may then be presented to a user (e.g., to display the types and values in a human-readable format) or may be further processed automatically. For example, the key-value pairs may be provided as input to some other software programmed to use the key-value pairs to perform some other activity.

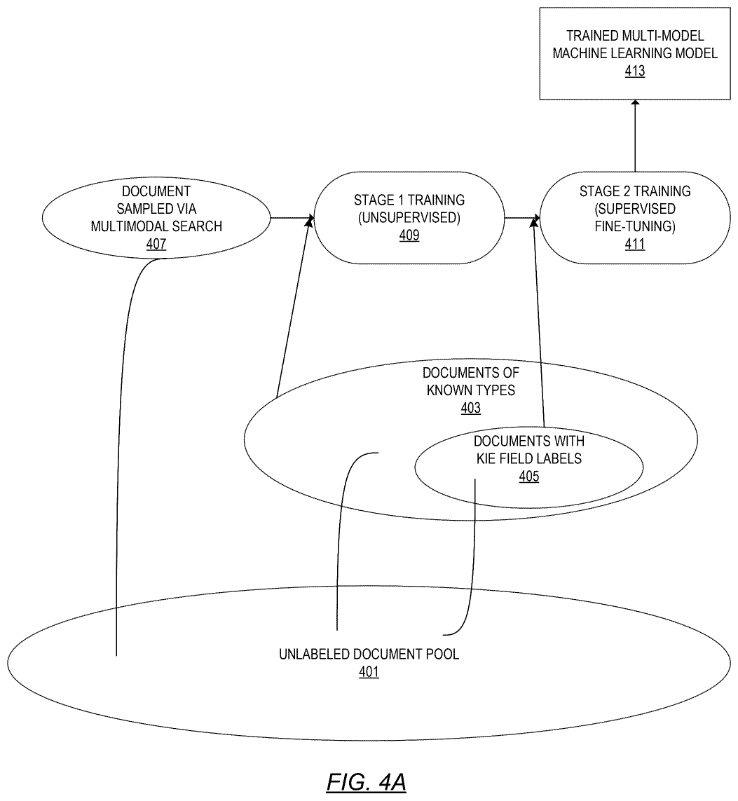

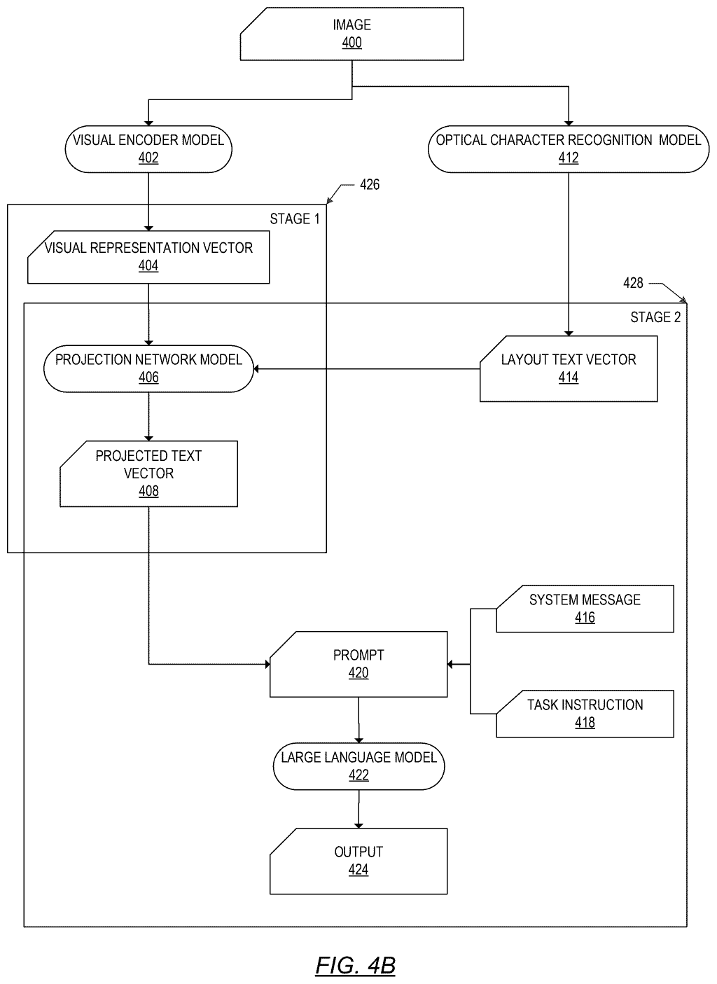

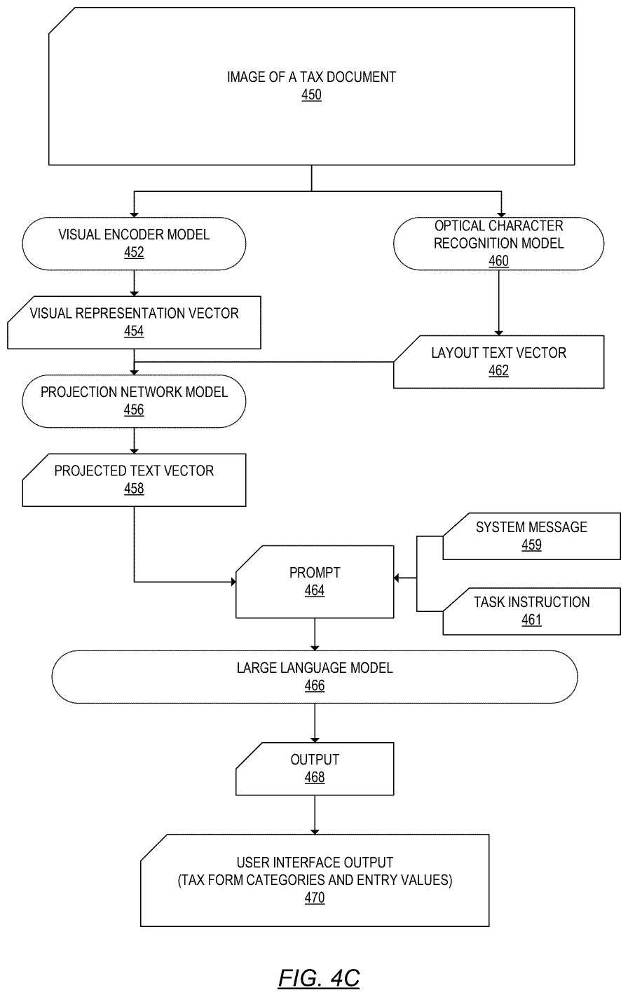

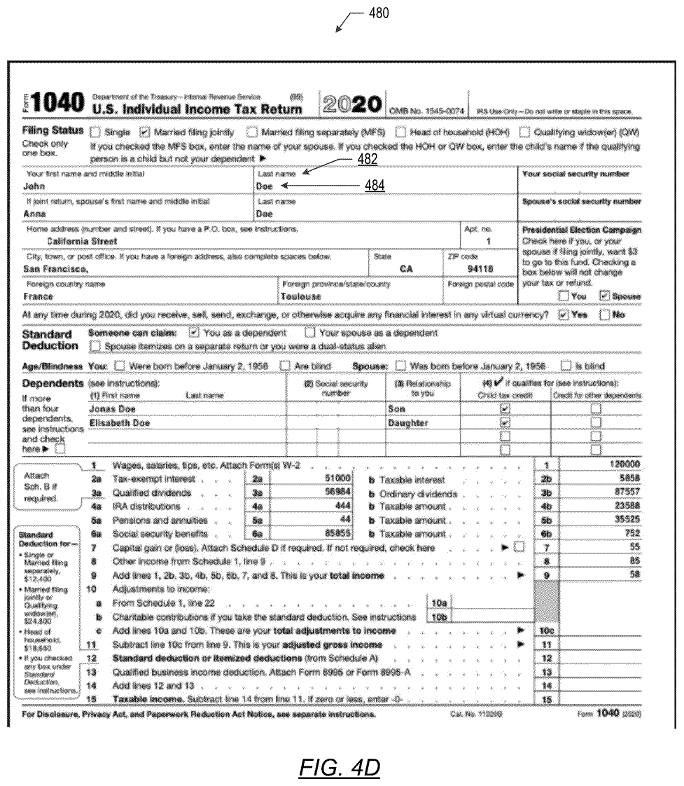

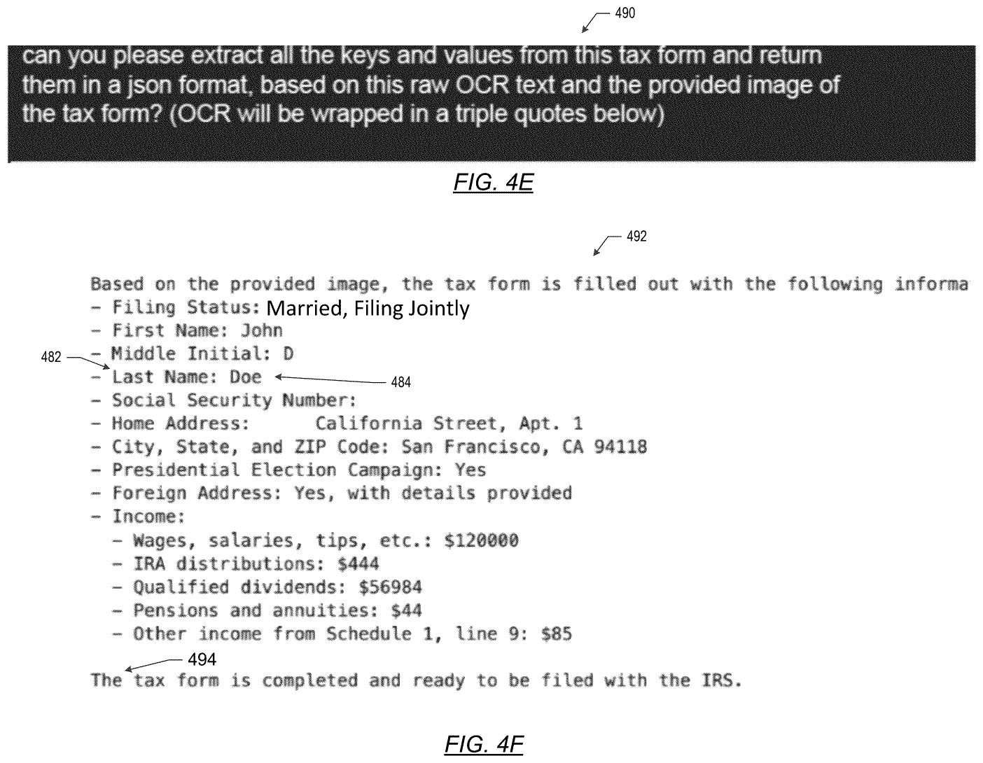

In a specific example, one or more embodiments may use the multi-modal machine learning model described herein to output the categorized text available in a digital image of a tax form. The categorized text may then be provided to automated tax preparation software which then uses the categorized text to automatically populate a tax form that may be submitted to a government agency, such as the United States Internal Revenue Service. A specific example of one or more embodiments used in this context is shown in FIG. 4A through FIG. 4F.

Attention is now turned to the figures. FIG. 1A shows a computing system, in accordance with one or more embodiments. The system shown in FIG. 1A includes a data repository (100). The data repository (100) is a type of storage unit and/or device (e.g., a file system, database, data structure, or any other storage mechanism) for storing data. The data repository (100) may include multiple different, potentially heterogeneous, storage units and/or devices.

The data repository (100) stores a digital image (102). The digital image (102) is a computer readable data structure that includes data which permits a computer to process the data to present a digital image on a user device. The data structure may be one of many different data types, such as .jpg, .png, .tif, and many others.

The digital image (102) includes text (104). The text (104) is, initially, a digital image containing shapes a human may read as text. This type of the text (104) is digital image text. A computer, without additional programming, cannot interpret digital image text as being computer-readable text (rather, the digital image text is just part of the image).

Digital image text is distinct from computer-readable text which a computer can directly interpret as text. A distinction between a digital image of text and computer-readable text exists because a computer may store a digital image as a digital image data structure and may store computer-readable text as a text data structure. The two data structures are distinct because, without more, the computer cannot directly read computer-readable text from a digital image. While optical character recognition algorithms or screen scraping algorithms can extract computer-readable text from a digital image of text, and then store the extracted computer-readable text as a text data structure, the digital image text does not contain a text data structure from the perspective of computer processing.

As used herein, the text (104) may be interpreted as either the digital image text or the computer-readable text. Thus, the text (104) may be stored either as a digital image data structure or as a text data structure. The “image data structure” is a data structure that stores the values of pixels that form the digital image. While the pixels may form shapes in the digital image (102) that a human might recognize as being text, those shapes are stored as the values of pixels in the digital image data structure, not as the text itself. In contrast, the “text data structure” is a data structure that stores computer-readable values that directly represent letters, words, numbers, or special characters.

Returning to the digital image (102), the text (104) in the digital image (102) may be presented in a layout (108). The layout (108) describes the physical arrangement of the text (104) within the digital image (102). For example, one instance of the text (104) may be located next to, beneath, above, etc. a second instance of the text (104).

Any instance of the text (104) may be located in a position (110) within the digital image (102). For example, an instance of the text (104) (or some other sub-image within the digital image (102)) may be located at a certain set of coordinates defined for the digital image (102). Alternatively, or in addition, the position (110) also may be described as the position of any one instance of the text (104) (or a sub-image within the digital image (102)) relative to another instance of the text (104) (or another sub-image within the digital image (102)) within the digital image (102).

The data repository (100) also stores a layout text vector (112). The layout text vector (112) is the output of an optical character recognition model (144) (see below). In general, a vector is a matrix. In many cases the matrix is a 1 by “N” matrix composed of features and values. A feature is a type of information being stored by the vector (e.g., whether a particular word or letter is present). A value is an entry for the feature that indicates the presence of the feature, the absence of the feature, a value for the feature, a probability that the feature is present, etc. Data may be said to be encoded in a vector or embedded in a vector. The terms “encoded” and “embedded” may be deemed synonymous herein. Encoded data or embedded data means that the data is stored in the vector format.

More specifically, the layout text vector (112) is a vector that encodes at least one word in the text of the digital image and also encodes a position of the at least one word in the layout of the digital image. For example, the layout text vector (112) may describe the numerical values of a table shown in the digital image (102) and further describe the arrangement of the numerical values of the table within the digital image (102).

Note that the layout of the digital image (102) in this example affects the meaning and context of the numbers that constitute the text (104). Without a description of the layout (108) of the text (104), a computer could not read the table as a table or understand the relationships of the numbers within the table.

In another example, the positions of text within the digital image (102) may help identify key-value relationships of the text (104) within the digital image (102). For example, one instance of the text (104) in the digital image (102) may indicate the category of information (the “key”), such as for example the phrase “last name”, and another instance of the text (104) in the digital image (102) may indicate the specifics of the information (the “value”), such as for example the word “Doe.”

Thus, the layout text vector (112) captures not only the text (104), but also the layout (108) of the text (104) within the digital image (102) and the position (110) of a word (106) in the digital image (102). However, the layout text vector (112) may not be in a computer data format suitable for input to a large language model or some other type of computing process. This fact is detailed further when describing the projected text vector (118), below.

The data repository (100) also stores a visual representation vector (114). The visual representation vector (114) is an output of a visual encoder model (146), defined below. The visual representation vector (114) embeds a content of the digital image. In other words, the visual representation vector (114) is a conversion of the data structure that defines the digital image (102) into a vector format.

Ordinarily, visual encoder models, such as a CLIP model or a BLIP model are machine learning models that take, as input, an image and generate, as output, a caption (116) that describes the contents of the image. For example, the visual encoder model (146) may analyze a digital image that contains a child who is reaching for a banana, and then generate a text data structure that describes the digital image as “a child reaching for a banana.”

Note that while a human may readily recognize the nature of the digital image (102), a computer cannot. Indeed, even using the visual encoder model (146), the caption “a child reaching for a banana” is merely a prediction by the visual encoder model (146), which may or may not be correct relative to how a human would interpret the digital image. For example, a human may view the digital image and readily recognize that the child is attempting to catch a falling banana, which is not the same as the caption text (116) above generated by the visual encoder model (146).

In one or more embodiments the caption text (116) may not be of interest to the techniques described herein. However, encoder models, such as visual encoder model (146) may have internal hidden layers that encode the digital image (102). The output of the internal hidden layers may take the form of a hidden representation vector (118). The visual encoder model may use the hidden representation vector (118) to generate the caption text (116). However, one or more embodiments may use the hidden representation vector (118) as the visual representation vector (114).

In other words, in an embodiment, the visual representation vector (114) and the hidden representation vector (118) may be synonymous. However, the distinction is made in order to make clear that while the visual encoder model (146) may be a CLIP, BLIP, or other type of encoder machine learning model, the output of interest of said model for purposes of one or more embodiments may be the hidden representation vector that represents the visual information in the digital image (102) in a vector format (i.e., the visual representation vector (114)).

The visual encoder model (146) may be pre-trained using contrastive objective for cross modality (text-image) alignment. The visual encoder (146) may be a CLIP machine learning model and a BLIP machine learning model, which may be pretrained on image-captioning datasets. Thus, referring back to the visual representation vector (114), the visual encoder model (146) may encode an entire image (broken down into a series of patches).

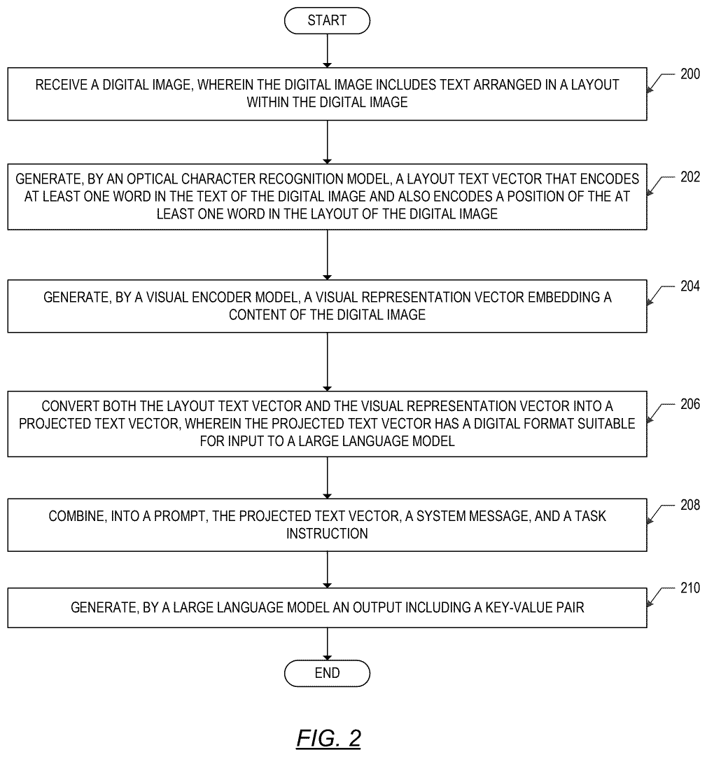

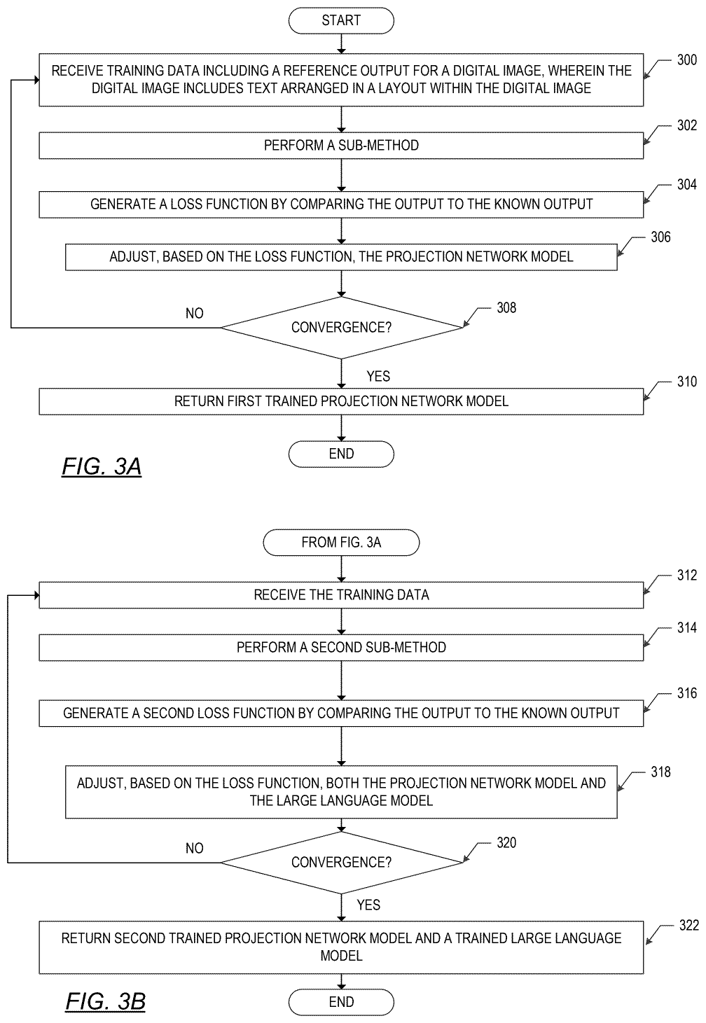

The data repository (100) also stores a prompt (120). The prompt (120) is one or more of a command, data, or a reference data for use as input to the large language model (150), described below. The prompt (120) is therefore formatted for use by the large language model (150). The prompt (120) may include several different components which, taken together, constitute the prompt (120). Generation of the prompt (120) is described with respect to FIG. 2.

The prompt (120) may include, or reference, a projected text vector (122) which the large language model (150) will process. The projected text vector (122) is the output of a projection network model (148) which took, as input, the layout text vector (112) visual presentation vector (114). The projected text vector (122) is also a vector that combines information from the visual presentation vector (114) and the layout text vector (112). Generation of the projected text vector (122) is described with respect to FIG. 2.

The prompt (120) also may include a system message (124). The system message (124) may specify the scope and capabilities of the large language model (150) when given a task. The system message may help set the behavior of the large language model (150). For example, the system message (124) may modify the response of the large language model (150) or provide specific instructions about how the large language model (150) should behave throughout the conversation. However, the system message may be optional in some embodiments.

The prompt (120) also may include a task instruction (126). The task instruction (126) is a specific instruction to the large language model (150) to perform a task.

The distinction between the system message (124) and the task instruction (126) is that the system message (124) may affect the systemic operation of the large language model (150), and the task instruction (126) may be a specific instruction to perform a task.

The following examples illustrate the difference between the system message (124) and the task instruction (126). In the example below, the terms “assistant” and “you” refers to the large language model (150).

Below is an example of the system message (124):

“You are a helpful, respectful and honest assistant and an expert in extracting data from documents. Always answer as helpfully as possible, while being safe. Your answers should not include any harmful, unethical, or illegal content. Please ensure that your responses are socially unbiased and positive in nature. If a question does not make any sense, or is not factually coherent, explain why instead of answering something is not correct. If you don't know the answer to a question, please don't share false information.”

Below is an example of the task instruction (126):

“Please extract key information from the following document. The optical character recognition text for the bank statement is provided below.

“““OCR TEXT””””

“Please output a JSON file with format. If the information is not present, do not include the corresponding key.”

The data repository (100) also may store an output (128). The output (128) is the output generated by the large language model (150). Generation of the output (128) is described with respect to FIG. 2. However, briefly, the output (128) includes at least one key-value pair (130).

The key-value pair (130) includes a key (132) and a value (134). The key (132) is a type of the text (104). The value (134) is one or more words, such as the word (106), that is the value of the type. For example, the key (132) may be “last name,” and the value (134) may be “Doe.”

The key (132) and the value (134) are associated with each other in pairs, and thus may be referred to as the key-value pair (130). There may be many instances of the key-value pair (130) that constitute the output (128) of the large language model (150). Furthermore, the key (132), the value (134), or both may include multiple words or terms. For example, as indicated above, the key (132) may be “last name,” which is two words that form a single key. In another example, the key (132) may be “full name” (2 words) and the value (134) may be “John William Doe” (3 words).

The data repository (100) also stores a reference output (136). The reference output (136) is the output of a machine learning model (e.g., one or more of the optical character recognition model (144), the visual encoder model (146), the projection network model (148), or the large language model (150)). However, the reference output (136) represents past results of a machine learning model that has been verified as being correct. In other words, the reference output (136) represents the answer that the machine learning model should generate when pre-determined training data is input to the machine learning model. Training data may be used to train a machine learning model, as described with respect to FIG. 1B.

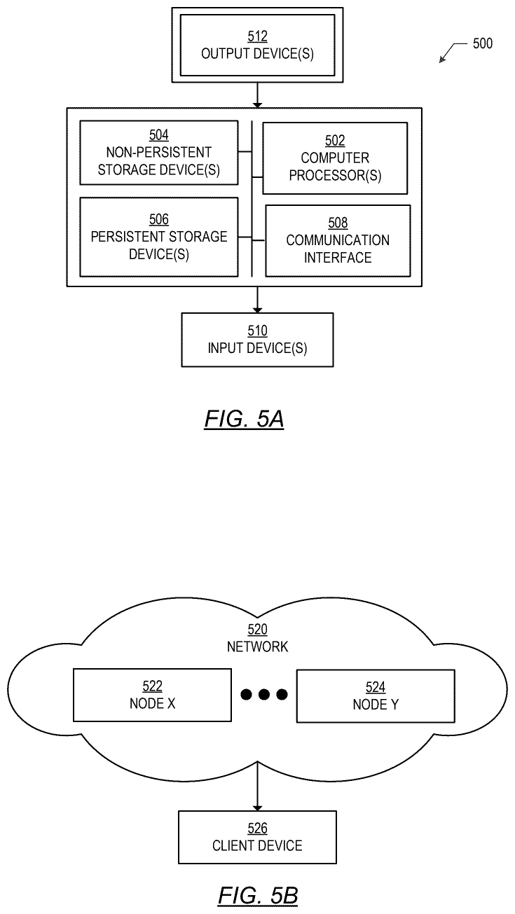

The system shown in FIG. 1A also includes a server (138). The server (138) is one or more processors and associated hardware and/or software, possibly operating in a distributed computing environment. The server (138) may be in communication with the data repository (100) via a direct connection or via an indirect connection, such as via a network. The server (138) may be the computing system shown in FIG. 5A.

The server (138) may include a computer processor (140). The computer processor (140) is one or more processors, which may be one or more of hardware processors and virtual processors. The computer processor (140) may be the computer processor(s) (502) of FIG. 5A.

The computer processor (140) may be used to execute the multi-modal machine learning model (142). The multi-modal machine learning model (142) is two or more machine learning models, such as but not necessarily limited to the optical character recognition model (144), the visual encoder model (146), the projection network model (148), and the large language model (150) described below. In general, a machine learning model is a computer-executable algorithm that finds hidden patterns in data, and which is trained prior to use.

The multi-modal machine learning model (142) may include an optical character recognition model (144). The optical character recognition model (144) is a machine learning model trained to process the digital image (102) to extract the layout text vector (112) from the digital image (102).

In an embodiment, the optical character recognition model (144) is considered to be outside the multi-modal machine learning model ensemble (142). For example, the optical character recognition model (144) may be an external model that is called by the system. In an embodiment the optical character recognition model (144) may not be fine-tuned, trained, or otherwise modified, and thus the optical character recognition model (144) may be supplied by a third party. Nevertheless, it also remains possible that the optical character recognition model (144) is, or at least is considered to be part of, the multi-modal machine learning model ensemble (142) as shown in FIG. 1A.

The multi-modal machine learning model (142) also includes the visual encoder model (146). The visual encoder model (146), as indicated above, is a machine learning model which takes, as input, the digital image (102) or a vector that contains the data of the digital image (102). The output of visual encoder model (146), generally, is the caption text (114). However, in the one or more embodiments, the output of the visual encoder model (146) is the output of the hidden layers of the visual encoder model (146), rather than the ordinary ultimate caption text (116) output of most encoder models. Thus, the output of the visual encoder model (146) is the hidden representation vector (118), which is the layout text vector (114). An example of the visual encoder model (146) may be a CLIP ViT-L/14 visual encoder, or a BLIP encoder. However, many different types of visual encoders may be used.

The multi-modal machine learning model (142) also includes a projection network model (148). The projection network model (148) is a machine learning model which is programmed to take, as input the visual representation vector (112) and the layout text vector (122) and generates, as output the projected text vector (122). The projection network model (148) may therefore embed the digital image (102) into the token space of the large language model (150), which effectively permits the large language model (150) to consider the layout of the text (104) in the digital image (102). An example of the projection network model (148) may be a neural network. However, many different machine learning models may be used for the projection network model (148).

The multi-modal machine learning model (142) also includes a large language model (150). The large language model (150) is a machine learning model which is processed to receive a prompt in the form of text, and possibly other textual information (see below) and to output additional text. The output of the large language model (150) depends on the prompt. For example, a prompt may ask the large language model to summarize a book. The large language model (150) receives the text of the book, and the prompt, as input and generates, as output, a summary of the contents of the book.

With respect to one or more embodiments, the output of the large language model (150) is the output (128). Thus, the output of the large language model (150) described herein is the key-value pair (130).

The computer processor (140) also may include other components, such as a prompt generator (152). The prompt generator (152) is hardware and/or software which is programmed to generate the prompt (120), such as by collating different information provided by a user into the prompt (120). The prompt generator (152) may be part of the large language model (150) in some embodiments.

The computer processor (140) also may include a training controller (154). The training controller (154) is hardware and/or software which is programmed to train one or more of the machine learning models of the multi-modal machine learning model (142). The description and operation of the training controller (154) is described with respect to FIG. 1B.

The system shown in FIG. 1A also may include a user device (156). The user device (156) is one or more computers that may interact with the server (138) or the data repository (100). For example, the user device (156) may provide the prompt (120) or may provide the user input that the prompt generator (152) uses to generate the prompt (120). In an embodiment, the user device (156) is external to the system shown in FIG. 1A, and in this case may communicate with the computer processor (140) or the data repository (100) via a network.

Attention is turned to FIG. 1B, which shows the details of the training controller (154). The training controller (154) is a training algorithm, implemented as software or application specific hardware, which may be used to train one or more the machine learning models of the multi-modal machine learning model (142) described with respect to the computing system of FIG. 1A.

In general, machine learning models are trained prior to being deployed. The process of training a model, briefly, involves iteratively testing model predictions against a test data set for which the final result is known, comparing the test results against the known results, and using the comparison to adjust the model. The process is repeated until the results do not improve more than some predetermined amount, or until some other termination condition occurs. After training, the final adjusted model (i.e., the trained machine learning model (192)) is applied to new input (e.g., the prompt (120) in the case of the large language model (150) in FIG. 1A) in order to make predictions.

In more detail, training starts with training data (176). The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, activation functions, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model being used (supervised versus unsupervised machine learning) or may be pre-determined by a user (e.g., convergence occurs after a set number of training iterations, described below).

In the case of supervised machine learning, the convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

In the case of unsupervised machine learning, the convergence process (184) may be to compare the output (182) to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on the training data for which the final result is not known (e.g., training data which, when processed by the machine learning model in question, generates the reference output (136) of FIG. 1A). Note that the trained parameter (194) in FIG. 1B may represent many different parameters of the machine learning model being trained. Thereafter, the output of the trained machine learning model (192) is then treated as a prediction of the information of interest relative to the unknown data.

While FIG. 1A and FIG. 1B shows a configuration of components, other configurations may be used without departing from the scope of the one or more embodiments. For example, various components may be combined to create a single component. As another example, the functionality performed by a single component may be performed by two or more components.

FIG. 2, FIG. 3A, and FIG. 3B show flowcharts of methods. The methods of FIG. 2. FIG. 3A, and FIG. 3B may be implemented using the system shown in FIG. 1A and FIG. 1B.

Attention is first turned to FIG. 2. FIG. 2 may be characterized as a method for identifying key-value pairs of text in a digital image, in accordance with an embodiment.

Step 200 includes receiving, by a processor, a digital image, wherein the digital image includes text arranged in a layout within the digital image. The digital image may be received from a user device. The digital image may be stored in a data repository and retrieved therefrom. The digital image may be received in a variety of different manners.

Step 202 includes generating, by an optical character recognition model, a layout text vector that encodes at least one word in the text of the digital image and also encodes a position of the at least one word in the layout of the digital image. Thus, the layout text vector captures not only the text in the digital image, but also the layout of the text within the digital image and the position of a word in the digital image. Thus, the optical character recognition model recognizes the shapes of objects in the digital image as being letters, numbers, words, special characters, etc., together known as text strings, and stores those text strings in a text data structure. The optical character recognition model also encodes into the layout text vector position information that records the positions of the text strings relative to each other.

Step 204 includes generating, by a visual encoder model, a visual representation vector embedding a content of the digital image. Again, the input of the visual encoder model is the digital image. However, rather than accepting the normal caption text that is output by the visual encoder model, the output of the hidden layers of the visual encoder model is captured instead. Thus, with respect to one or more embodiments, the output of the visual encoder model is a hidden representation vector that encodes the content of the digital image in a vector format. The hidden representation vector is the visual representation vector (114).

Step 206 includes converting both the layout text vector and the visual representation vector into a projected text vector, wherein the projected text vector has a digital format suitable for input to a large language model. Converting the layout text vector and the visual representation vector into the projected text vector may be performed by a projection network model. The projection network model receives both vectors as input and generates, as output, the projected text vector.

The projection network model effectively transforms, or embeds, the data in the other two vectors into the token space of the large language model, which effectively permits the large language model to consider the layout of the text in the digital image. Transforming the other two vectors into the token space means that the data in the other two vectors is transformed into a textual format readable by the large language model. While a human may not, in some cases, be able to resolve words and or human-readable text in the projection vector, the projection vector nevertheless contains the information in the other two vectors-but now that information is stored in a text format.

Step 208 includes combining, into a prompt, the projected text vector, a system message, and a task instruction. Combining may be performed by using a prompt generator to indicate all three of the projected text vector, the system message, and the task instruction. The combination of all three is then provided to the large language model, which sorts and processes each type of input according to the type of input (i.e., the large language model recognizes the projected text vector as the input data upon which the task instruction will be executed in view of the parameters set by the system message).

See, for example, FIG. 4E for an example command useful for a prompt to be provided to the large language model. Yet further, the prompt may include information such as additional reference material (e.g., a tax code or instructions for filling out a form), or commands regarding how to return keys and values, or other desirable commands or data sources. Thus, step 208 may combine additional information to that mentioned in step 208.

In an embodiment, the prompt may be generated for a zero shot inference without demonstration. In this case, the prompt is generated to include both the command and a key name of the key in the key-value pair.

Zero shot inference means that not a single example of the digital image is available. Thus, the multi-modal machine learning ensemble may not have been trained on similar documents as the current document being processed. Zero shot inference is difficult in machine learning models, because machine learning models generally rely on vast amounts of training data during training in order to make predictions that are accurate to within a predetermined degree.

Demonstration is a machine learning paradigm that allows a machine learning model, especially large language models, to learn to perform a task by imitating the behavior of an expert shown demonstrations. Thus, “without demonstration” means that the machine learning model has not been trained to imitate the behavior of an expert or the output of some other model.

Therefore, zero shot inference without demonstration is a very difficult problem when using machine learning to generate a prediction that is acceptably accurate. However, in this particular example, by providing both the command and the key name of the key in the key-value pair, the large language model may make such an accurate prediction even for zero shot inferences without demonstration.

Zero-shot inference without demonstration may be achieved in one or more embodiments by using other techniques (i.e., by providing information other than the command and the key name of the key in the prompt to be input to the large language model). For example, the prompt may be generated to include a document type of the digital image. For example, informing the large language model that the document type is a W-2 form tax document may permit the large language model to draw inference based on other tax documents included in the training data used to train the large language model.

In addition to the above, the prompt may be generated for a few shot inference with demonstration. In this case, the large language model has been permitted to observe a demonstration by an expert or some other model and the demonstration is included as an input at inference time. In this case, the prompt may specify that the input with corresponding desired output (e.g. the digital image with the correct key-value pairs). In other words, less additional information may be provided when generating the prompt, relative to performing zero shot inferences without demonstration.

Note that one or more embodiments may be performed on documents that do not constitute zero shot (without demonstration) or few shot (with one or a few demonstration) inferences. However, the above examples are provided to show that prompt engineering (i.e., changing the data or the commands, or both, that are provided in the prompt to the large language model) may be used to accomplish zero shot or few shot inferences to within a pre-determined degree of accuracy. Accordingly, one or more embodiments may be used to process rare or possibly unique forms represented by a digital image.

Step 210 includes generating an output including a key-value pair. As indicated above, the key of the key-value pair represents a type of the text and a value of the key-value pair represents a value of the text. The output is generated by the large language model which takes, as input, the prompt. The output of the large language model may be more than just the key-value pair, but at a minimum includes key value pairs.

In an example, the command may be specific to a desired key-value pair (e.g., find last name and the value of the last name). In another example, the command may be to extract multiple of key-value pairs from the text (see FIG. 4F). In still another example, the key-value pair generated at step 210 is one of the multiple of key-value pairs (e.g., the method of FIG. 2 may generate multiple key-value pairs or may be executed multiple times to generate multiple key-value pairs for multiple images).

The method of FIG. 2 may be robust compared to other image processing techniques for determining the text and the meaning of the text contained in the digital image. For example, when a digital image is rotated relative to an orientation of the text, then optical character recognition algorithms (whether based in machine learning or more traditional optical character recognition algorithms) may have difficulty generating the text to an acceptable pre-determined degree of accuracy.

However, one or more embodiments may overcome this difficulty because the layout text vector (via the projected text vector) permits the large language model to consider the impact that the layout of the digital image has on the meaning of the text shown in the digital image. Thus, one or more embodiments may be used to determine the key-value pairs to within a pre-determined accuracy even when the digital image is rotated relative to the orientation of the text.

Attention is now turned to FIG. 3A. FIG. 3A may be characterized as a method of training a machine learning model. The method of FIG. 3A in particular may be characterized as a method of training the projection network model in a first training stage. For example, FIG. 3A may be considered an example of training stage 1 (426) of FIG. 4B.

Step 300 includes receiving training data including a reference output for a digital image, wherein the digital image includes text arranged in a layout within the digital image. In other words, what is received is training data. The training data is a digital image which includes text arranged in the layout. The correct output (i.e. reference output) is known. In other words, it is known what the machine learning model should output in terms of key-value pairs, as the correct key-value pairs of the text in the digital image are already known. The digital image itself and the reference output may be stored in a data repository and retrieved therefrom, or may be received from a remote data source.

Step 302 includes performing a sub-method. The sub-method includes some, but not necessarily all, of the steps described with respect to the method of FIG. 2. The steps mentioned below for the sub-method are described with respect to FIG. 2, but the sub-method performed for FIG. 3A is as follows.

The first step of the sub-method is to generate, by a visual encoder model, a visual representation vector embedding a content of the digital image. The second step of the sub-method is to convert, using a projection network model, the visual representation vector into a projected text vector, wherein the projected text vector includes a digital format suitable for input to a large language model.

The sub-method also includes a fourth step, which is different than the method described with respect to FIG. 2. In particular, the method also includes generating, using a large language model that takes the prompt as input, an output including a sequence of next tokens in an optical character recognition text determined for the text in the image. A token, in natural language processing, is a word, part of a word, a number, or a special character (including punctuation, symbols, etc.) The tokens therefore are optical character recognition text (i.e., text directly readable by a computer processor as being text, as opposed to image text that is stored as pixels which form shapes that a human might interpret as text when viewing the image as a whole). Thus, the fourth step of the sub-method is to generate an output that includes the sequence of tokens that are determined from the image text in the image.

Note that the process of using reference values for key-value pairs is used for stage 2 training (FIG. 3B), not for stage 1 training (FIG. 3A). In contrast, the sub-method for stage 1 training (FIG. 3A) uses the digital image and corresponding optical character recognition text extracted from the digital image.

Step 304 includes generating a loss function by comparing the output to the reference output. The loss function may be instructions to adjust one or more tunable aspects of the projection network model, such as hyperparameters, or other adjustable aspects of the machine learning model used for the projection network model. Thus, generating the loss function may include executing instructions that modify the aspects of the projection model in a manner that may cause the projection network to generate a new output that is closer in value or values to the reference output.

Step 306 includes adjusting, based on the loss function, the projection network model. Adjusting the projection network model may be performed automatically, such as replacing or otherwise modifying the tunable aspects of the projection network model.

Step 308 includes determining whether convergence has been achieved. Convergence may be achieved upon reaching a pre-determined condition. For example, if the output of the projection network model exactly matches the reference output or matches the pre-determined output to within a pre-determined degree, then convergence is achieved. In another example, convergence may be achieved after a pre-determined number of iterations of the method of FIG. 3A.

If convergence is not achieved (a “no” at step 308), then the process returns to step 300 and repeats. However, the repeated method is performed using the version of the projection network model adjusted at the prior instance of step 306.

Once convergency has been achieved (a “yes” at step 308), step 310 includes returning a first trained projection network model. Returning the first trained projection model may be performed by storing the trained projection model. Considering FIG. 3A as a whole, the method of FIG. 3A may be characterized training a first trained projection network model by iterating, until convergence, receiving the training data, performing the sub-method, generating the loss function, and adjusting the one or more parameters, wherein upon convergence the projection network model is transformed into the first trained projection network model.

In the method of FIG. 3A, the visual encoder model, the optical character recognition model, and the large language model may be frozen. The optical character recognition model also may be frozen. The term “frozen,” as used herein, means that the parameters of the frozen machine learning model are not modified during a training operation of some other machine learning model, even when both models are involved in the training of the model that is not frozen. Thus, in this example, it is possible during stage 1 of training that only the projection network model is trained, even though the large language model and other models of the multi-model model ensemble are used during the training of the projection network model. In other words, the visual encoder model and the large language are not trained or modified in the method of FIG. 3A.

However, in a second training stage, only the visual encoder model may be frozen, in which case adjusting further includes adjusting both the projection network model and the large language model. Accordingly, in the method of FIG. 3A, receiving, performing, generating, adjusting, and training, may be a first training operation. For the second training stage, the method may repeat while training both the trained projection network model and the large language model. This procedure for a second training stage is shown in FIG. 3B. Note that the visual encoder model and the optical character recognition model also may be frozen during the second training stage of FIG. 3B.

Step 312 includes receiving the training data. Step 312 is similar to step 300 of FIG. 3A.

Step 314 includes performing a second sub-method. The second sub-method is similar to the first-sub-method of the first training stage in FIG. 3A. However, the second sub-method includes additional steps. For example, the second sub-method includes generating, by the optical character recognition model, a layout text vector that encodes at least one word in the text of the digital image and also encodes a position of the at least one word in the layout of the digital image. The generation of the layout text vector is similar to step 202 of FIG. 2.

In stage 2 training, the second sub-method also modifies the converting step. Namely, converting includes converting both the layout text vector and the visual representation vector into the projected text vector, similar to step 206 of FIG. 2.

Next, the second sub-method includes combining into the prompt the projected text vector, a system message, and a task instruction. Combining is similar to step 208 of FIG. 2.

Then, the second sub-method generates a different output, relative to the first sub-method. Namely, the sub-method generates the key of the key-value pair based on the output of a large language model that takes, as input, the prompt. The generation of the key-value pair of the second sub-method is similar to step 210 of FIG. 2.

However, step 316 includes generating a second loss function by comparing the second output to the reference output. However, at step 316, the output of the large language model is compared to the reference output for the large language model. Accordingly, a second loss function is generated.

Step 318 includes adjusting, based on the loss function. is used to update the trained projection network model that was obtained at step 310 of FIG. 3A. In other words, the projection network model is further refined and updated, which generates a second trained projection network model.

Concurrently, the loss function is used to change the tunable parameters of the large language model. The process of updating and training the large language model is similar to the process of training the projection network model. However, the loss function for the large language model is different and the tunable aspects of the two models may be different. Nevertheless, the result of step 318 is both an adjusted projected network model and an adjusted large language model.

Step 320 includes determining whether convergence has occurred. Step 320 is performed independently for both the projection network model and for the large language model. Thus, convergence may occur first for one model before convergence occurs for the other model.

If convergence is not achieved (a “no” at step 320), then the process returns to step 312 and repeats. However, the repeated method is performed using the version of the projection network model, or for the large language model, (whichever model is to be further adjusted) that had been adjusted at the prior instance of step 318.

Once convergency has been achieved (a “yes” at step 320), step 322 includes returning a second trained projection network model (when convergence is achieved for the projection network model) and a trained large language model (when convergence is achieved for the large language model). Returning the trained models may be performed by storing the trained models.

Considering FIG. 3B as a whole, the method of FIG. 3B may be characterized as training a first trained projection network model by iterating, until convergence, receiving, performing, generating, and adjusting. Upon convergence, the first projection network model is refined into the second trained projection network model, and the large language model is transformed into the trained large language model.

Note that during the method of FIG. 3B, the visual encoder model may be frozen during both the first training operation and the second training operation. Thus, while the visual encoder model may be involved in the process of training the projection network model and the large language model, the visual encoder model is not updated during either training stage 1 (FIG. 3A) or training stage 2 (FIG. 3B). In an embodiment, the visual encoder model (and possibly the optical character recognition model, when the optical character recognition model is a machine learning model) may be trained prior to either training stage described in FIG. 3A or FIG. 3B. The training of the visual encoder model (or possibly the optical character recognition model) may proceed as described with respect to FIG. 1B.

While the various steps in the flowcharts of FIG. 2, FIG. 3A, and FIG. 3B are presented and described sequentially, at least some of the steps may be executed in different orders, may be combined or omitted, and at least some of the steps may be executed in parallel. Furthermore, the steps may be performed actively or passively.

A detailed example is now provided in FIG. 4A through FIG. 4F. The example is in the context of processing a digital image of a tax document. It is desirable that the keys and values of the tax document be determined accurately so that the keys and values may be provided to some other tax processing software which automatically prepares taxes for a user who supplied the digital image of the tax document.

The following example is for explanatory purposes only and not intended to limit the scope of the one or more embodiments. In the example of FIG. 4A through FIG. 4F, the tax document is uncommon or unique. Thus, the example of FIG. 4A through FIG. 4F may be considered a zero shot inference (without demonstration) or few shot inference with demonstration.

FIG. 4A shows an example of the type of information available to train a particular multi-modal machine learning model (413) (e.g., the multi-modal machine learning model (142) of FIG. 1A). The available training data includes an unlabeled document pool (401). In machine learning, a label is metadata associated with training data that labels or describes the underlying data. Labeled data is used for supervised machine learning, which may result in a more accurate task specific trained machine learning model. Unlabeled data is used for unsupervised machine learning model, which does not require labels for training, but which may result in a trained machine learning model that are not fine-tuned to perform specific tasks.

The unlabeled document pool (401) may include a few documents which are labeled or partially labeled. For example, there may be a subset of documents in the unlabeled document pool (401) which are documents of known types (403). The documents of known types (403) represent those documents in the unlabeled document pool (401) for which the type of document is labeled (e.g., the document is labeled a 1099 form or a W-2 form), but which is not otherwise labeled.

Within the documents of known types (403) may be documents with key information entities (KIE) field labels; i.e., the documents with KIE field labels (405). The documents with KIE field labels (405) include labels for at least some of the data within the documents. The KIE field labels label text in the digital image as being known keys (i.e., known types of text).

When the multi-modal machine learning model is to be trained, a number of selected documents may be selected from the unlabeled document pool (401). In particular, a multi-modal search may be performed to select the document sampled via multi-modal search (407) shown in FIG. 4A. In addition, the documents of known types (403) may be selected. These unlabeled, or partially labeled, documents may then be used in an unsupervised training process for the projection network model training (i.e., the stage 1 training mentioned in FIG. 3A). The unsupervised training process may not yield a machine learning model trained to perform specific task (such as document extraction) but is adapted to domain specific representation (e.g. how document images are different from natural scene images and how texts in tax document are different from natural language conversation texts), but the amount of data available may be much larger. Thus, the stage 1 training may still be beneficial for adapting the model ensemble to document domain data, particularly in training the projection network model.

Then the documents with KIE field labels (405) may be used in the stage 2 training, during which a supervised machine training process is performed using the labels available for the documents with KIE field labels (405). The stage 2 training trains both the projection network model and the large language model, and thus refines those to models. The result of stage 2 training is a trained multi-model machine learning model ensemble (413).

FIG. 4B shows an example of the two-stage training process for the multi-modal machine learning model ensemble, such as the multi-modal machine learning model (142) of FIG. 1A. Thus, FIG. 4B is a representation of the methods shown in the combination of FIG. 3A and FIG. 3B and provides more details for the training process shown in FIG. 4A.

The process starts with receiving a digital image (400), which in this example is a 1040 tax form promulgated by the United States Internal Revenue Service (see FIG. 4D). The digital image (400) includes text in a layout, and the layout of the text conveys meaning to the text. For example, the fact that a number is entered line 3b means that the number associated with line 3b has a particular meaning (i.e., ordinary dividends). While a simple optical character recognition algorithm may extract the text string “3b” and the text string “87,557” next to each other, the optical character recognition algorithm may not return that the value of 3b is 87,557. Thus, subsequent tax preparation software could not properly process the text scraped or recognized from the digital image (400). The training and processing performed in FIG. 4A and FIG. 4B solve this technical problem.

After receiving the digital image (400), a vectorization process is performed on the digital image (400). Vectorization transforms the data that represents image (400) into a vector format, and thus generates a digital image vector. The visual encoder model (402) takes the digital image vector as input. The visual encoder model (402) outputs the visual representation vector (414). The visual representation vector (414) may be the visual representation vector (114) of FIG. 1A, and generated according to step 204 of FIG. 2.

Concurrently, or possibly sequentially, the optical character recognition model (412) may take, as input, the digital image (400). The optical character recognition model (412) generates as output the layout text vector (414).

Then, the projection network model (406) converts the visual representation vector (414) and the layout text vector (414) into the projected text vector (408). The projected text vector (408) may be the projected text vector (122) of FIG. 1A according to step 206 of FIG. 2.

The projected text vector (408) (or a reference to the projected text vector (408)), a system message (416), and a task instruction (418) are combined in a prompt (420). The prompt (420) is then fed as input to the large language model (422). The large language model (422) generates the output (424), which is key-value pairs present in the digital image (400). For example, the output may be “3b” associated with “87,557.” Another example of the output is shown in FIG. 4F.

Initially, the output (424) may be in a computer-readable format, such as a JAVASCRIPT® object notation (JSON) file. However, the output (424) also may be converted from the JSON file to a human readable format for presentation to a user, such as shown in FIG. 4F.

During stage 1 training (426), the output (424) is compared to a reference output. A loss function is generated, but only for the projection network model (406). The visual encoder model (402) and the large language model (416) are frozen during the stage 1 training (426). The stage 1 training (426) continues until convergence is achieved in the projection network model (406), resulting in a first trained version of the projection network model (406). Note also that, during stage 1 training, the layout text vector system message and task instruction may not be input to the large language model.

The process may be repeated during a training stage 2 (428). The training stage 2 (428) repeats the entire process described above, but this time the loss function is used to update both the projection network model (406) (which is a first trained projection network model) and the large language model (416). The visual encoder model (402) is frozen during the training stage 2 (428). The training process continues until convergence for both the projection network model (406) and the large language model (416). The result is a refined, second trained version of the projection network model (406) and a trained version of the large language model (416).

The inference stage of machine learning is very similar to the above process. The process is repeated, but this time the digital image (400) is not a known image for which the output is known. During inference, the output (424) is the predicted key-value pairs of text contained in the digital image (400). This inference process is shown in FIG. 4C.

In FIG. 4C, the digital image is the digital image of a tax document (450), such as the form 1040 shown in FIG. 4D. The digital image of a tax document (450) is vectorized by converting the data that forms the digital image into a digital image vector. The visual encoder model (452) takes the digital image vector as input and generates, as output, the visual representation vector (454). Again, the visual representation vector (454) is a vector that encodes the image of a tax document (450).

In addition, the optical character recognition model (460) takes, as input the image of a tax document (450). The optical character recognition model (460) generates, as output, the layout text vector (462). The layout text vector (462) embeds the text in the image of a tax document (450) in a text data structure, and also embeds the position information that describes the positions of the text within the image of a tax document (450).

Together, the visual representation vector (456) and the layout text vector (462) are provided, as input, to the projection network model (456). The projection network model (456) generates, as output, the projected text vector (458). Again, the projected text vector (458) contains the information in the visual representation vector (454) and the layout text vector (462). However, the projected text vector (458) is in a token space (i.e. in a text format) such that the large language model (466), described below, can process the information in the projected text vector (458).

The projected text vector (458), a system message (459), and a task instruction (461) are combined into a prompt (464). The prompt (464) is then provided as input to the large language model (466).

The large language model (466) generates the output (468). The output (468) is key-value pairs. Again, the key-value pairs are instances of keys associated with values. The keys are instances of categories of text contained in the digital image text of the digital image of a tax document (450). The values are text strings that define the specific information of interest in the category represented by the key. Examples of key-value pairs are shown in FIG. 4F.

The output (468) may be in the form of a JSON® data structure, or some other computer-readable data structure. When the output (468) is in a computer-readable format, the output (468) may be provided automatically to some other process, such as for example automated tax preparation software. Thus, for example, the digital image of a tax document (450) may be a 1040 tax form from a prior year. The output (468) thus may be key-value pairs that represent the user's name, income, etc., all of which now may be provided to tax preparation software which automatically populates a current year 1040 tax form. The user of the software, or the software itself, may then make adjustments to the current year's 1040 tax form. For example, a W-2 for the current year may be analyzed using the method of FIG. 4C, and then the information in the W-2 form used to automatically adjust the 1040 tax form for the current year.

In addition, it is possible to convert the computer readable format into the user interface output (470). The user interface output (470) represents the data in a human-readable format. Thus, for example, the parsed tax form categories and the entry value for those categories may be presented as human-readable text laid out in a manner easy for a user to understand. An example of the user interface output (470) is shown in FIG. 4F.

Attention is turned to FIG. 4D. FIG. 4D shows an example of the digital image of a tax document (450) in FIG. 4C. Specifically, the tax form (480) shown in FIG. 4D is a tax form 1040 promulgated by the United States Internal Revenue Service. The tax form (480) includes a key (482) (“Last Name”) and a value (484) (“Doe”). Note, however, that without the techniques described herein, optical character recognition algorithms, even machine-learning based optical character recognition algorithms, cannot associate the semantic association between the key (482) and the value (484).

However, one or more embodiments do permit the semantic association (i.e. category and category value, or “key” and “value”) to be parsed by the computer. One reason that the semantic association can be made is because the layout of the key (482) relative to the value (484) within the tax form (480) image permits a computer to make the semantic association between the two. Specifically, by using an encoder model to generate a visual representation vector captures an image, together with an optical character recognition model that captures the layout text vector, all of the relevant information in the image may be captured. However, to leverage the ability of a large language model to recognize the meaning of text, the layout text vector and the visual representation vector may be converted into a projected text vector which may be received by the large language model. In turn, the projected text vector may be combined with a system message and a task instruction into a prompt which is input to the large language model. The output of the large language model includes the key-value pairs, such as the key (482) and the value (484) in FIG. 4D.

FIG. 4E shows an example of the task instruction that is included together with the projected text vector and the optical character recognition text as input to the large language model. The prompt (490) asks the large language model to extract keys and values from this tax form (i.e., the digital image of a tax document (450)) and return the keys and values in a JSON® format. Note that the prompt (490) also refers to the “raw OCR text” (i.e., the optical character recognition text described above) and to the projected text vector (described in the prompt (490) as “the provided image of the tax form”). The prompt (490) is then issued to the large language model, which outputs the key-value pairs.

FIG. 4F shows an example user interface output (492) that includes the key-value pairs mentioned above. For example, one of the keys may be the key (482) (“Last Name”), and the associated value of the key may be the value (484) (“Doe”). In other words, the computer is able to distinguish from the digital image the association between the text string “Last Name” and the text string “Doe” as being a key-value relationship where “Last Name” is the key and “Doe” is the value.

Note that the example user interface output (492) shown in FIG. 4F is the user interface output (470) described with respect to FIG. 4C. The example user interface output (492) may have been generated from the JSON data structure which is output by the large language model.

In addition, the large language model also may draw conclusions regarding the digital image of a tax document (450). For example, the large language model may output an evaluation (494) regarding whether the 1040 tax form is completed. In this example, the large language model is able to determine that the arrangement of key-value pairs in the digital image of the 1040 tax form satisfy the rules set forth by the U.S. Internal Revenue Service (IRS). Thus, the evaluation (494) is that the tax form is completed and ready to be filed with the IRS.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (512). The inputs may include text input, audio input, video input, etc., which may be processed and transmitted by the computing system (500) in accordance with the disclosure. The communication interface (508) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (512) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform all or a portion of one or more embodiments.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a digital image, wherein the digital image comprises text arranged in a layout within the digital image;
generating, by an optical character recognition model, a layout text vector that encodes at least one word in the text of the digital image and also encodes a position of the at least one word in the layout of the digital image;
generating, by a visual encoder model, a visual representation vector embedding a content of the digital image;
converting both the layout text vector and the visual representation vector into a projected text vector, wherein the projected text vector comprises a digital format suitable for input to a large language model;
combining, into a prompt, the projected text vector, a system message, and a task instruction; and
generating an output comprising a key-value pair, wherein:
a key of the key-value pair represents a type of the text and a value of the key-value pair represents a value of the type, and
the output is generated by the large language model which takes, as input, the prompt.

2. The method of claim 1, wherein the visual representation vector comprises a hidden representation vector output by a plurality of inner layers of the visual encoder model.

3. The method of claim 2, wherein the visual representation vector excludes a caption text for the digital image.

4. The method of claim 1, wherein:
converting comprises inputting a combination of the layout text vector and the visual representation vector to a projection network model,
the projection network model outputs the projected text vector, and
the projection network model projects the layout text vector and the visual representation vector into a textual token embedding space.

5. The method of claim 1, wherein:
the task instruction is to extract the key-value pair, or
the task instruction is to extract a plurality of key-value pairs from the digital image, and
the key-value pair is one of the plurality of key-value pairs representing key information entities in a document.

6. The method of claim 1, wherein:
the prompt is generated for a zero shot inference without demonstration, and
the prompt is additionally generated to include both the task instruction and a demonstration comprising a multimodal input followed by an expected output represented as a known key-value pair in a structured format.

7. The method of claim 1, wherein:
the prompt is generated for a zero shot inference without demonstration, and
the prompt is generated to include meta-information including a document type of the digital image.

8. A method comprising:
receiving training data comprising a reference output for a digital image, wherein the digital image comprises text arranged in a layout within the digital image;
performing a first sub-method comprising:
generating, by a visual encoder model, a visual representation vector embedding a content of the digital image;
converting, using a projection network model, the visual representation vector into a projected text vector, wherein the projected text vector comprises a digital format suitable for input to a large language model;
combining, into a prompt, the projected text vector, a system message, and a task instruction; and
generating, using a large language model that takes the prompt as input, an output comprising a sequence of next tokens in an optical character recognition text determined for the text in the image;
generating a loss function by comparing the output to the reference output;
adjusting, based on the loss function, one or more parameters in the projection network model; and
training a first trained projection network model by iterating, until convergence, receiving the training data, performing the first sub-method, generating the loss function, and adjusting the one or more parameters, wherein upon convergence the projection network model is transformed into the first trained projection network model.

9. The method of claim 8, wherein the visual encoder model and the large language model are frozen such that only the one or more parameters of the projection network model are trained.

10. The method of claim 8, wherein the visual encoder model is frozen, and wherein adjusting further comprises adjusting both the projection network model and the large language model.

11. The method of claim 8, wherein receiving, performing, generating, adjusting, and training comprise a first training operation, and wherein the method further comprises a second training operation comprising:
re-receiving the training data;
performing a second sub-method comprising:
generating, by an optical character recognition model, a layout text vector that encodes at least one word in the text of the digital image and also encodes a position of the at least one word in the layout of the digital image;
generating, by a visual encoder model, a visual representation vector embedding a content of the digital image;
converting, using a projection network model, both the layout text vector and the visual representation vector into a projected text vector, wherein the projected text vector comprises a digital format suitable for input to a large language model;
combining, into a prompt, the projected text vector, a system message, and a task instruction; and
generating an output comprising a key-value pair, wherein:
a key of the key-value pair represents a type of the text and a value of the key-value pair represents a value of the type, and
the output is generated by the large language model which takes, as input, the prompt;
generating a second loss function by comparing the second output to the reference output;
adjusting, based on the loss function, the one or more parameters of both the first trained projection network model and the large language model; and
training a second trained projection network model and a trained large language model by iterating, until convergence, re-receiving the training data, re-performing the second sub-method, generating the second loss function, and adjusting the one or more parameters, wherein:
upon convergence the first trained projection network model is transformed into the second trained projection network model and the large language model is transformed into the trained large language model; and
the trained large language model is adapted for extraction of the key-value pair.

12. The method of claim 11, wherein:
the visual encoder model and the large language model are frozen during the first training operation such that the projection network model is trained during the first training operation, and
the visual encoder model is frozen during the second training operation such that both the first trained projection network model and the large language model are trained during the second training operation.

13. The method of claim 12, further comprising:
receiving, after the second training operation, a new digital image;
performing the second sub-method a third time on the new digital image; and
presenting the key-value pair extracted from the new digital image.

14. A system comprising:
a computer processor;
a data repository in communication with the computer processor and storing:
a digital image comprising text arranged in a layout within the digital image,
a layout text vector that encodes at least one word in the text of the digital image and also encodes a position of the at least one word in the layout of the digital image,
a visual representation vector embedding a content of the digital image,
a projected text vector, wherein the projected text vector comprises a digital format suitable for input to a large language model,
a prompt,
a system message,
a task instruction, and
an output comprising a key-value pair, wherein a key of the key-value pair represents a type of the text and a value of the key-value pair represents a value of the type;
an optical character recognition model which, when executed by the computer processor, is programmed to generate the layout text vector;
a visual encoder model which, when executed by the computer processor, is programmed to generate visual representation vector;
a projection network model which, when executed by the computer processor, is programmed to generate the projected text vector;
a prompt generator which, when executed by the computer processor, is programmed to generate the prompt by combining the projected text vector, the system message, and the task instruction; and
the large language model which, when executed by the computer processor, is programmed to generate the output comprising the key-value pair.

15. The system of claim 14, further comprising:
a training controller which, when executed by the computer processor, is programmed to train only the projection network model in a first training stage to generate a trained projection network model.

16. The system of claim 15, wherein the training controller is further programmed to train both the trained projection network model and the large language model in a second training stage.

17. The system of claim 14, further comprising:
a training controller which, when executed by the computer processor, is programmed to:
receive training data comprising a reference output comprising a reference digital image;
perform a first sub-method comprising:
generating, by the visual encoder model, the visual representation vector;
converting the visual representation vector into the projected text vector;
combining, into the prompt, the projected text vector, a system message, and a task instruction; and
generating, using a large language model that takes the prompt as input, an output comprising a sequence of next tokens in an optical character recognition text determined for the text in the image;
generate a loss function by comparing the output to the reference output;
adjust, based on the loss function, at least one parameter of the projection network model; and
training a first trained projection network model by iterating, until convergence, receiving the training data, performing the sub-method, generating the loss function, adjusting the at least one parameter, wherein upon convergence the projection network model is transformed into the first trained projection network model.

18. The system of claim 17, wherein receiving, performing the sub-method, generating the loss function, adjusting, and training comprise a first training operation, and wherein the training controller is further programmed to perform a second training operation comprising:
re-receiving the training data comprising:
a reference digital image comprising reference text;
a reference prompt comprising a reference digital image, a reference system message, and a reference task instruction, and
a reference output comprising a reference key-value pair, wherein a reference key of the reference key-value pair represents a reference type of the text and a reference value of the reference key-value pair represents a reference value of the reference type;
perform a second sub-method comprising:
generating, by an optical character recognition model, a layout text vector that encodes at least one word in the reference text of the reference digital image and also encodes a position of the at least one word in the layout of the reference digital image;
generating, by a visual encoder model, a visual representation vector embedding a content of the reference digital image;
converting, using a projection network model, both the layout text vector and the visual representation vector into a projected text vector, wherein the projected text vector comprises a digital format suitable for input to a large language model;
combining, into a prompt, the projected text vector, a system message, and a task instruction;
generating an output comprising a key-value pair, wherein:
a key of the key-value pair represents a type of the text and a value of the key-value pair represents a value of the type, and
the output is generated by the large language model which takes, as input, the prompt; and
generating a second loss function by comparing the second output to the reference key-value pair of the reference output;
adjusting, based on the second loss function, both the first trained projection network model and the large language model; and
training a second trained projection network model and a trained large language model by iterating, until convergence, the receiving, the performing, the generating, and the adjusting of the second training operation,
wherein upon convergence the first trained projection network model is transformed into the second trained projection network model and the large language model is transformed into the trained large language model.

19. The system of claim 14, wherein the visual representation vector comprises a hidden representation vector output by a plurality of inner layers of the visual encoder model.

20. The system of claim 19, wherein the visual representation vector excludes a caption text for the digital image.
